(19) United States
(12) Patent Application Publication
(10) Pub. No.: US 2021/0060827 A1
(43) Pub. Date: Mar. 4, 2021

(54) METHOD OF PRODUCING AN OPERATING FLUID TANK

(71) Applicant: KTM AG, Mattighofen (AT)

(72) Inventors: Hans LOCHNER, Ramsau bei Berchtesgaden (DE); Matthias RAWA, Hof bei Salzburg (AT); Robert STADLBAUER, Groedig (AT)

(21) Appl. No.: 17/004,757

(22) Filed: Aug. 27, 2020

(30) Foreign Application Priority Data
Aug. 30, 2019 (AT) A 50758/2019

(51) Int. Cl. B29C 39/26; B29C 33/76; B29C 45/14; B33Y 80/00

(52) U.S. Cl. CPC B29C 39/26; B29C 33/76; B29L 2031/30; B33Y 80/00; B29C 45/14819

(57) ABSTRACT

A method of producing an operating fluid tank includes providing a mold core produced from a mold core material. The mold core has a holding region, by which the mold core is held in a tool mold or in a plastic molding machine. The mold core is surrounded with a plastic melt, and an opening remains in the operating fluid tank. The mold core material is removed from the operating fluid tank by the remaining opening, and a structural element is arranged at the mold core separate from the holding region, and is held by the mold core while being surrounded with the plastic melt. An inner surface of the operating fluid tank is then formed, to which a structural feature arranged on the structural element is transferred. The structural element is removed from the operating fluid tank through the remaining opening after at least partial hardening of the melt.

### BACKGROUND OF THE INVENTION

The present invention concerns a method of producing an operating fluid tank of plastic for a motor vehicle including providing a mold core produced from a, preferably pourable or flowable, mold core material. The mold core has at least one holding region, by way of which the mold core is held in a tool mold or in a plastic molding machine, surrounding the mold core with a plastic melt. At least one opening remains in the operating fluid tank in the at least one holding region, by way of which the mold core is held in a tool mold or a plastic molding machine, and removing the mold core material from the operating fluid tank by way of the remaining opening.

In addition, the invention concerns a mold core for the production of an operating fluid tank of plastic for a motor vehicle and an operating fluid tank for a motor vehicle.

It is known in the state of the art to use mold cores for the production of hollow bodies of plastic. In that case, generally a pourable or flowable mold core material, preferably a granular material, is used to produce a mold core, the mold core material in that case usually being presssed into a certain shape. Then the mold core is held in the cavity of a tool mold or a plastic molding machine and surrounded with liquid plastic melt. After being subjected to pressure and after hardening the mold core together with the plastic casing is removed and possibly flushed out with the aid of a solvent so that ultimately this results in the production of a hollow body of plastic, the shape of which corresponds to the surface of the mold core. Such a mold core is also known as a lost mold core. Such a mold core and a method for the production of a fiber-reinforced hollow structural component with a mold core is shown in DE 10 2013 106 876 A1.

WO 2017/148997 also concerns a mold core for the production of a fiber-reinforced hollow component, wherein the mold core has a support core with an at least region-wise arranged coating which includes an expansion material. In that arrangement a matrix with reinforcing fibers is disposed on the mold core. The mold core is then put into a mold core tool. The matrix is hardened by means of an increase in temperature and/or pressure, the expansion material expanding with the increase in temperature and thereby pressing reinforcing fibers against the inside of the mold tool.

WO 2017/148998 discloses a fiber-reinforced hollow structural component, wherein arranged in the mold core is a passage into which reinforcing fibers and/or matrix material are introduced. After hardening of the matrix material and flushing out of the mold core the material introduced into the passage remains as a reinforcing element, in particular as a reinforcing strut in the hollow structural component. The reinforcing element is produced simultaneously with the surface of the hollow component and is connected in positively locking and material-bonded relationship to the wall of the hollow structural component.

WO 2018/108674 concerns a lost mold core for the production of a fiber-reinforced component, wherein the mold core is of a segmented configuration. An elastic and/or flexible compensating element is disposed between the segments, whereby a translatory and/or rotational displacement between the two segments can be compensated in the production of the component. For the production operation the reinforcing fibers can be arranged with the matrix around the lost mold core before the mold core is hardened in a mold tool. In addition a reinforcing element can be pressed on an outside surface of the component. The reinforcing element can harden jointly with the matrix so that this gives a material-bonded connection between the reinforcing element and the matrix. Fixing means can also be arranged on the reinforcing element, for example a thread insert, a sleeve, a hook and/or a bore. In that way the fixing means with the reinforcing element can be easily arranged at the outside on the component to be produced.

JP 2003-291208 and JP-H10119055 disclose methods of producing a fuel tank by means of a lost mold core, in which a solid plastic is arranged in the form of extruded plate-shaped semi-finished articles around the mold core, in which case shut-off valves are held in the mold core by gravity by the mold core. The extruded plastic semi-finished articles are pressed with the mold core and thereby connected to the shut-off valves. The overlapping regions of the plastic semi-finished products are welded. A further plastic layer can then be applied around the pressed plastic semi-finished product, for example by means of an injection molding process. That process suffers from the disadvantage that the shut-off valves are only inadequately held by the operating fluid tank.

A disadvantage with the state of the art is the lack of any possibility of processing the interior of a hollow component produced with a mold core or arranging insert components at predetermined locations in the interior of the hollow body and fixing them there such that they cannot be lost. That concerns in particular operating fluid tanks for motor vehicles.

### SUMMARY OF THE INVENTION

Therefore the object of the invention is to provide a method with which an operating fluid tank of plastic is produced by means of a mold core, wherein the inner surface of the operating fluid tank is to be especially processed and/or an insert member is to be arranged at a predetermined location in the interior of the operating fluid tank and fixed there.

To produce an operating fluid tank of plastic according to the invention for a motor vehicle, firstly a mold core which is preferably produced from a pourable or flowable mold core material is provided. For example, the mold core material can include a binding agent and/or a granular material, wherein the granular material can include in particular a mineral base substance like for example a glass, a ceramic material and/or sand.

The mold core has at least one holding region, by way of which the mold core is held in a tool mold or in a plastic molding machine, for example an injection molding machine. Such tool molds and plastic molding machines are known in principle in the state of the art. In that respect, the holding region can comprise the same material as the rest of the mold core. The holding region can also, for example, be in the form of a metallic or ceramic holding element. The holding element can be provided with fixing means, for example a thread, with which the mold core can be held in a plastic molding machine or a tool mold.

Depending on the respective nature of the plastic molding machine or that machine by which plastic melt is introduced into the tool mold, the mold core is surrounded with liquid or pasty plastic melt. For example, plastic melt is introduced into a tool mold or a plastic molding machine, whereby the mold core has plastic melt injected around and/or behind it. In that case, it is possible to use injection molding machines which are known per se in the state of the art, thereby providing an inexpensive production method. An opening remains in the operating fluid tank to be produced, at the holding region, by way of which the mold core is held in the tool mold or the plastic molding machine, as the core is not possible to be surrounded with plastic melt in that region.

The most widely varying plastic materials can be used for the method according to the invention, for example thermoplastics like, for example, polypropylene (PP), polyamides (like for example polyamide 6), polyethylene (like for example crosslinked polyethylene EXPE) or high-density polyethylene (HDPE)), co-polymers (like for example ethylene-vinyl alcohol co-polymer (EVOH)). Mixtures of polypropylene and polyethylene are also possible.

It is also possible to use fiber-reinforced plastics, in which respect all possible variants can be considered like for example carbon fiber-reinforced plastics (CRP) or glass fiber-reinforced plastics (GRP). In that case, it is possible for the fibers to be arranged on the mold core prior to being surrounded with the plastic melt.

After at least partial hardening of the plastic, the mold core material is removed from the operating fluid tank by way of the remaining opening. For that purpose, in the case of a mold core material with a binding agent, it may be advantageous if that binding agent is soluble by means of a solvent and in that way the mold core material can be easily flushed out of the opening. Such a solvent can include for example an acid, a base, water and/or an alcohol. In the case of a mold core material without binding agent the mold core material can also be easily removed from the interior of the operating fluid tank with water or with compressed air.

According to the invention, arranged at a limited portion of the mold core that is separate from the holding region, is a structural element which is held by the mold core while being surrounded with liquid or pasty plastic melt. In the operation of surrounding the core with the plastic melt, an inner surface of the operating fluid tank is formed, to which a structural feature arranged on the structural element is transferred while being surrounded with the plastic melt during hardening of the plastic melt. In that case, the structural element is between the core and the operating fluid tank and influences the final shape of the operating fluid tank on the inside thereof.

That structural feature can be, for example, a geometrical structure on the structural element, wherein a negative shape of that geometric structure is produced on the inside wall of the operating fluid tank. That method can be employed, for example, to produce passages on regions of the inside of the operating fluid tank, whereby it is possible to implement a particular flow behaviour on the part of the operating fluid. In an embodiment, the structural feature is formed by a smooth surface of the structural element. When that structural feature is transferred on to the inner surface of the operating fluid tank, the region which is opposite the structural element when the core is being surrounded with the plastic melt has a very smooth inside wall. A smooth surface of that kind may be necessary for example in an operating fluid tank in order to serve as a contact surface for a flange subsequently arranged in the operating fuid tank or to make it easy for fuel or oils which are stored in the operating fuid tank to run off. A portion of the inside wall of the operating fluid tank with a very smooth surface can also serve as wear protection or as a support surface for components arranged in the interior of the operating fluid tank.

The structural element can preferably comprise a metallic and/or ceramic material. For example insert elements can be used for the structural element. Those insert elements can influence the surface roughness on the inside of the operating fluid tank and for example create a particularly smooth internal surface. Depending on the respective configuration of the structural element ribs, baffle walls, filling passages, sealing surfaces or threads can also be formed on the inside of the operating fluid tank. With ribs on the inside, it is possible for especial parts of the operating fluid tank to be reinforced and made more stable. Baffle walls make it possible to prevent major shifts in the operating fluid while the vehicle is moving. That is relevant in particular for fuel tanks and motorcycles with which great lean angles can occur. It is particularly advantageous in that respect that the ribs and the baffle walls are an integral constituent of the operating fluid tank and are created simultaneously with the production thereof and comprise the same material. It is possible in that way to reduce or avoid stresses in the operating fluid tank.

In an embodiment of the invention, the structural element has a flat surface region on which the structural feature or features is or are arranged. In that way flat surface regions of the inside of the operating fluid tank for example can be provided with a geometrical structure or can be particularly smooth.

After the core is surrounded with the plastic melt and after the melt has at least or entirely hardened the structural element is removed from the operating fluid tank optionally after fragmentation of the structural element through the remaining opening, preferably at the same time as or after removal of the mold core material. That is possible as soon as the operating fluid tank is at least of a certain hardness.

According to the invention, additionally or alternatively to the arrangement of a structural element at a limited portion of the mold core, that is separate from the holding region, a functional element which is stable in shape is arranged there and is held by the mold core while it is being surrounded with liquid or pasty plastic melt. In that case, the functional element can be held by the mold core in particular in positively locking or force-locking relationship. In the operation of surrounding the mold core with the plastic melt an inner surface of the operating fluid tank is formed, to which the functional element is connected when the mold core is being surrounded with the plastic melt. After hardening of the plastic melt and removal of the mold core material from the operating fluid tank, which is possible after at least partial or complete hardening of the plastic melt, the functional element is connected to the operating fluid tank in material-bonded and/or positively locking relationship in such a way that the functional element has access to the interior of the operating fluid tank.

In that way, it is possible that at least one side of the functional element remains free even after being connected to the operating fluid tank, and the function to be performed by the functional element can relate to the interior of the operating fluid tank. The functional element can be, for example, an electronic functional element which has a sensor and/or a transmitting and/or receiving unit. Such a sensor can detect for example the filling level of the operating fluid tank or the state of the operating fluid in the operating fluid tank, and can transmit it by way of a sending unit in order for example to display a warning in the display of the motor vehicle.

In the case of a sensor, this can also be a piezoelectric sensor which gives information about pressure states in the interior of the operating fluid tank. The functional element can, for example, also have an open-loop and/or closed-loop control unit, wherein depending on the respective state of the operating fluid open-loop or closed-loop control signals are passed to the motor vehicle or such signals are obtained depending on the operating state of the vehicle. The functional element can also include for example an integrated temperature sensor which also gives information about the state of the operating fluid. In addition or alternatively, the functional element can also have further sensors, for example for the filling level in the operating fluid tank, for the pressure in the operating fluid tank, for measurement of the through-flow in the operating fluid tank and/or for measurement of the spacing in relation to other articles arranged in the operating fluid tank. This may also involve a chip which permits identification of original components. Replacement of the chip and thus misuse is practically impossible by virtue of being arranged in the interior of the tank. In addition location of stolen motor vehicles could also be possible by way of the transmitting and receiving unit.

The functional element can also include a sealing element and/or a fixing element. Particularly in the case of a fuel tank various feed and discharge lines are arranged in the interior of the tank, for example for liquid fuel to be fed to the engine or for evaporated fuel to go to an activated carbon filter. Gas-tight or liquid-tight connections to the feed and discharge lines can be ensured with sealing elements which are already arranged in the interior of the operating fluid tank at predetermined locations. A fixing element can be for example a threaded insert with which additional components can be fixed in the interior of the operating fluid tank. The threaded insert however can also be arranged on the mold core in a region adjoining the holding region. By way of such a threaded insert it may be possible for example to fix the operating fluid tank as such in the motor vehicle.

The functional element can also be, for example, a cable guide duct which is arranged in the interior of the operating fluid tank and is fixedly connected to the tank. That makes slipping of the cable duct impossible, in particular when the cables are being drawn in.

Various inserts, for example of metal, plastic, ceramic or hybrid material can however also serve as the functional element, which perform various functions in the interior of the operating fluid tank. Such inserts can be for example fixing means with which other items subsequently arranged in the operating fluid tank can be fixed in place like for example the feed line to the carburettor or also any connecting elements. Inserts can also serve as guide and holding elements, for example for the cable duct. The functional element however can also be in the form of a switch which can be arranged in the interior of the operating fluid tank with the method according to the invention.

The functional element which is stable in shape fulfils the purpose of not being deformed while being surrounded with the plastic melt and thereby not being restricted in terms of its function. The arrangement and the fact it is held on the mold core while it is being surrounded with the plastic melt ensures that the functional element or also the structural element is placed at the predetermined region in the interior of the tank or the structural features are transferred to the predetermined region.

The operating fluid tank according to the invention can be a fuel tank, an oil tank or however also a tank for other operating fluids like for example brake fluid. As injection molding machines are also provided for the arrangement of the plastic melt in accordance with the method of the invention operating fluid tanks can be injection molded in accordance with the invention. In that case it is possible for an insert member in the form of a functional element which is stable in shape to be fixed at a predetermined location in the interior of the injection-molded operating fluid tank or for a desired condition in respect of the inner surface to be created at a predetermined location.

An operating fluid tank produced in accordance with the emthod according to the invention has the advantage that structural elements can be arranged in the interior of the operating fluid tank or functional elements can be placed stationarily in the interior of the tank without the tank having to be subsequently closed after placement of the functional element or after the processing operation at the inside thereof. Therefore no weld seams are required. In addition such an operating fluid tank can be produced with a constant and predefined wall thickness. That is an important safety aspect. More specifically it is possible in that way for the operating fluid tank to have a wall thickness which is as thin as possible but which is still nonetheless sufficient from the safety point of view. In that way it is possible to produce light operating fluid tanks without having to suffer a degradation in relation to safety.

In an embodiment, the mold core can have two or more holding regions, by way of which the mold core is held in a tool mold or a plastic molding machine, for example an injection molding machine. In that way the mold core is held in a more stable fashion in the tool mold or the plastic molding machine. In addition, removal of the mold core material is more easily possible. At the same time, operating fluids can be fed or discharged by way of the opening or openings in the operating fluid tank, that remain in a or in a plurality of the holding regions.

In an embodiment of the invention, the functional element and/or the structural element is held in positively locking relationship by the mold core while being surrounded with plastic melt. For that purpose, certain regions of the structural element and/or the functional element can serve as holding regions, and the mold core material can be arranged around those holding regions during production of the mold core.

Additionally or alternatively, the functional element and/or the structural element is held in force-locking relationship by the mold core while being surrounded with plastic melt. For that purpose, a male thread can be arranged on the structural element and/or the functional element and the mold core can have an opening with a matching female thread. The functional element and/or the structural element is then arranged in that opening and held by the thread. That permits a particularly firm hold.

Additionally or alternatively, the functional element and/or the structural element can be held by the mold core in material-bonded relationship while the core is surrounded with plastic melt. For that purpose, the structural element and/or the functional element can be glued on the mold core by an adhesive.

A positively locking, force-locking and/or material-bonded connection permits a particularly stable connection of the mold core to the functional element and/or the structural element so that the risk of the functional element and/or the structural element slipping while the core is surrounded with the plastic melt is reduced.

Arranged on the at least one holding region can be a preferably metallic holding means with which the mold core is held in a tool mold or a plastic molding machine. That holding means can have for example a male thread or other fixing means.

In an embodiment, the mold core can be composed of at least two segments, wherein two respective segments are connected together by way of a connecting means. The connecting means can be for example an elastic compensating means to compensate for a translatory or rotational displacement. After the core is surrounded with the plastic melt the connecting means is removed from the operating fluid tank through the remaining opening. Geometries with undercut configurations can also be easily implemented by means of a segmented mold core.

The mold core can include a granular material, wherein the granular material can comprise sand and/or foam balls. Foam balls have the advantage of low weight, whereby handling of the mold core is facilitated. Sand of a grain size of between 170 and 220 μm can be considered for the mold core. By way of example a standard polystyrene granular material of a grain size of between 1 and 5 mm can be considered as the foam balls.

In an embodiment, the mold core can have a casing comprising a soluble or crushable material. Such casings for mold cores are known per se in the state of the art. With a casing surface it can be possible to dispense with binding agent for the mold core arranged within the casing.

The mold core can be produced with a 3D printing process known per se in the state of the art. That provides advantages in particular in regard to the arrangement of the functional element and/or the structural element.

The invention further concerns a mold core for the production of an operating fluid tank of plastic for a motor vehicle in accordance with one of the above-described methods. In that case, the mold core can have a region of a special configuration, in which the structural element or the stable-shape functional element is held while the core is surrounded with the plastic melt.

The invention further concerns an operating fluid tank for a motor vehicle, wherein the operating fluid tank is produced by way of a plastic injection molding method, preferably in accordance with a method as described hereinbefore.

### BRIEF DESCRIPTION OF THE DRAWINGS

Further advantages and details of the invention will be discussed for various embodiments by way of example with reference to the following Figures in which:

FIG. 1 is a diagrammatic cross-sectional view of an operating fluid tank with mold core arranged therein,

FIG. 2 is a partly sectional diagrammatic perspective view of a mold core composed of segments,

FIGS. 3a through 3c are diagrammatic views relating to the arrangement of a functional element in the interior of an operating fluid tank and relating to the transfer of structural elements on to the inner surface of an operating fluid tank,

FIG. 4 is a diagrammatic view of an internal region of an operating fluid tank with transferred structural feature,

FIG. 5 is a diagrammatic view relating to the arrangement of a mold core in a tool mold, and

FIGS. 6a through 6e are diagrammatic views relating to the method procedure according to the invention.

### DETAILED DESCRIPTION OF THE INVENTION

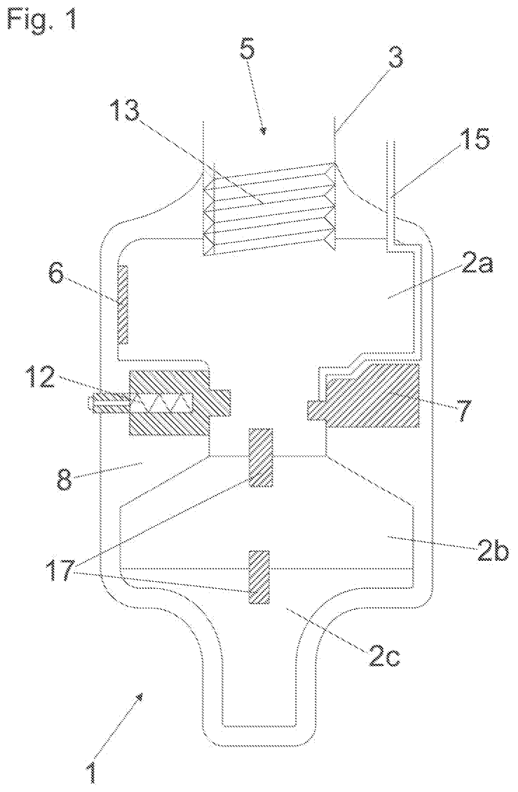

FIG. 1 is a diagrammatic cross-sectional view showing a mold core 2 according to the invention which is composed of three segments 2a, 2b, 2c, the segments 2a, 2b, 2c being respectively connected by way of a connecting means 17. At limited portions of the mold core 2 a structural element 6 and a stable-shape functional element in the form of a sensor 12 are held by the mold core 2. Further stable-form functional elements which are held at limited portions of the mold core 2 are a fixing element 13 in the form of a thread, a cable duct 15 and a general functional element 7, for example an RFID chip. The structural element 6 and the functional elements 7, 12, 13, 15 are held by the mold core 2 while being surrounded with the plastic melt 8. FIG. 1 shows the operating fluid tank after at least partial hardening of the plastic melt 8 and after removal from the tool mold 4. Subsequently the mold core 2a, 2b and 2c, the connecting means 17 and the structural element 10 are removed from the interior of the operating fluid tank 1.

In the situation shown in FIG. 1 the mold core 2 according to the invention is already surrounded with a partially hardened plastic melt 8 in the form of a thermoplastic material. After hardening of the melt 8 the functional elements 7, 12, 13 and 15 are held by the operating fluid tank in material-bonded and/or positively locking relationship. The structural element 6 has a flat surface region with a structural feature 10 arranged thereon, for example a smooth surface which is transferred to the inner surface 9 of the operating fluid tank when the core is surrounded with the plastic melt 8.

The above-mentioned limited regions are separate from the holding region 3 at which the mold core 2 is held in a tool mold 4. After hardening of the plastic melt 8 the mold core material is removed by way of the opening 5 which remains in the operating fluid tank 1 at the holding region 3. The connecting means 17 and the structural element 6 are also removed by way of the remaining opening 5.

Particularly in regard to the functional element 7 and the sensor 12 it can be seen that those elements are arranged in an undercut region of the operating fluid tank 1 and are therefore surrounded with plastic melt 8 apart from accesses to the interior and the exterior of the operating fluid tank. In that case in regard to the sensor 12 a region on the outside of the operating fluid tank 1 is accessible, for example to connect a data or control line. The undercut configurations are possible in particular by virtue of the segmentation of the mold core 2.

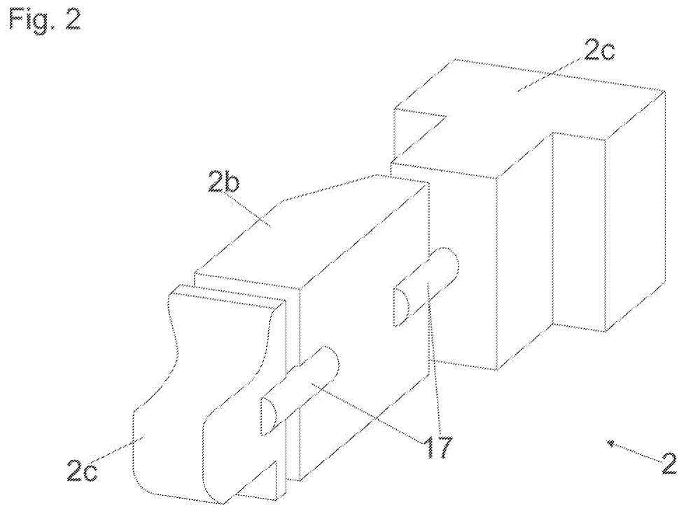

FIG. 2 is a perspective diagrammatic view of the mold core 2 according to the invention, wherein the segments 2b and 2c shown in FIG. 1 are illustrated in section so that the connecting means 17 with which the segments 2a, 2b and 2c are connected together can be seen. The segment 2c is shown in its complete form. Such segments 2a, 2b and 2c permit strongly undercut configurations for the operating fluid tank.

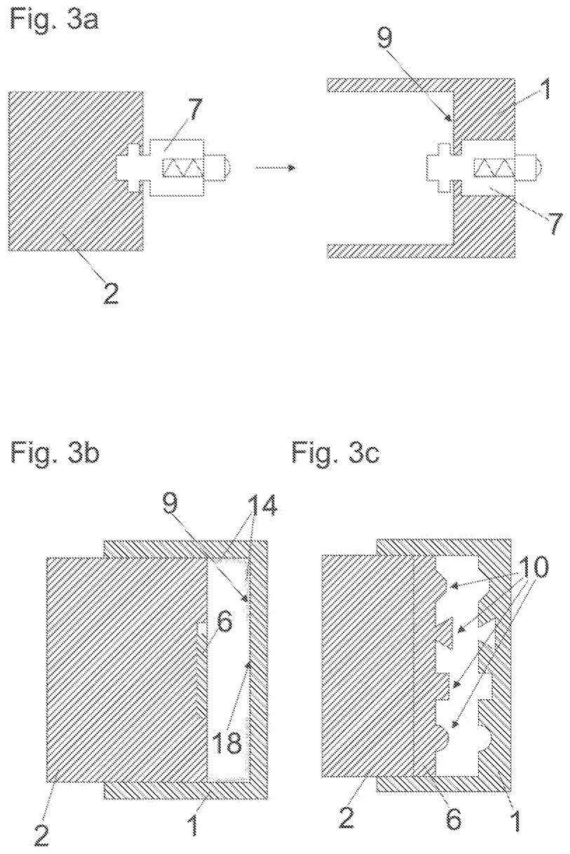

FIG. 3a in the left view shows how a function a element 7, for example a piezoelectric element, is held by the mold core 2. The functional element 7 has holding regions which project perpendicularly from its longitudinal extent and around which the mold core material is arranged so that this affords a positively locking connection between the functional element 7 and the mold core 2. The mold core 2 is surrounded with plastic melt 8, for example a thermoplastic material, for example in a tool mold 4. When then the plastic melt 8 hardens the stable-shape functional element 7 after removal of the mold core material is held by the operating fluid tank according to the invention in positively locking and material-bonded relationship and has access to the interior in order for example to detect data in respect of the content of the operating fluid tank 1. At the same time in this case the functional element 7 is held by the operating fluid tank 1 in such a way that access still remains to the exterior of the operating fluid tank 1, for example to connect a data or control line.

FIG. 3b diagrammatically shows how a structural feature 10 in the form of a smooth surface on a flat region of a structural element 6, which is held by the mold core 2 while being surrounded with plastic melt 8 is transferred on to the inner surface 9 of an operating fluid tank 1 according to the invention and comprising a thermoplastic material. In that case a negative configuration of the surface of the structural element 6 is transferred. After removal of the mold core material there remains a region 18 in which the inner surface 9 of the operating fluid tank 1 is smooth while the inner surface 9 apart therefrom constitutes a region 14 with a rough surface.

FIG. 3c diagrammatically shows how a structural element 6 having a flat region on which structural features 10 in the form of different rib shapes are arranged is transferred on to the inner surface 9 of an operating fluid tank 1 according to the invention. The structural element 6 is held by the mold core 2 while being surrounded with plastic melt 8. That results in a negative shape in respect of the rib configurations on the inner surface 9 of the operating fluid tank in the region in which the structural element 6 was held by the mold core 2 while being surrounded with the plastic melt 8. The rib shapes make it possible for the inner surface 9 of the operating fluid tank 1 to have for example different undercut configurations in that region, thereby achieving particularly high stability.

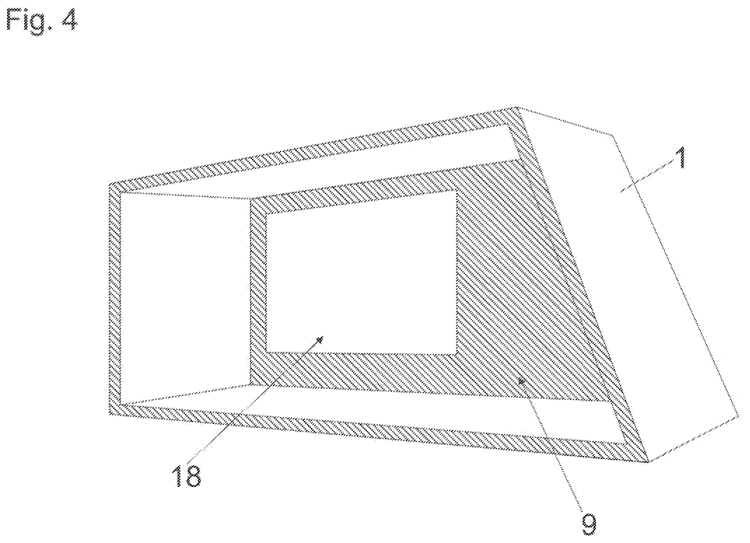

FIG. 4 is a diagrammatic perspective view showing the inner region of an operting fluid tank 1 according to the invention, wherein a region 18 has a smooth surface which was transferred by the transfer of a structural feature 10 of a structural element 6. That surface region represents a smooth negative configuration for the surface region of the structural element 6. In comparison the region 15 has a rough surface which is produced when surrounding the mold core 2 with plastic melt 8. FIG. 3b diagrammatically shows by way of example how such a structural feature 10 in the form of a smooth surface is transferred on to the inside wall of the operating fluid tank 1.

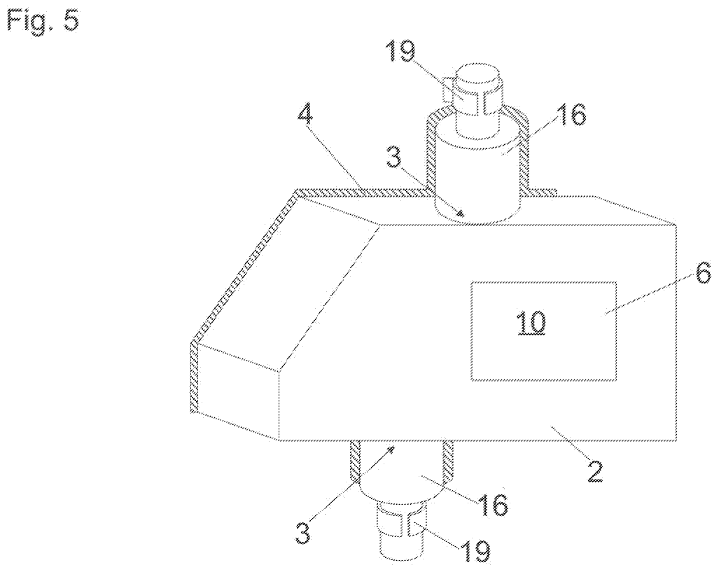

FIG. 5 is a diagrammatic view showing how a mold core 2 according to the invention is held in a tool mold 4 of a plastic injection molding machine.

A structural element 6 is adhesively attached to the mold core 2 and is thereby held by the mold core 2 while being surrounded with plastic melt 8. A structural element 10 in the form of a smooth surface is thereby transferred on to the inner surface 9 of the resulting operating fluid tank 1 according to the invention. The mold core 2 has two holding regions 3, by way of which the mold core 2 is held in the tool mold 4. For that purpose holding means 16, for example in the form of metal pins, are arranged on or in the mold core 2. The holding means 16 are held by way of clips 19 in the tool mold 4. After the mold core 2 is surrounded with plastic melt and after hardening, removal of the mold core material and removal of the holding means 16 openings 5 remain in the operating fluid tank 1.

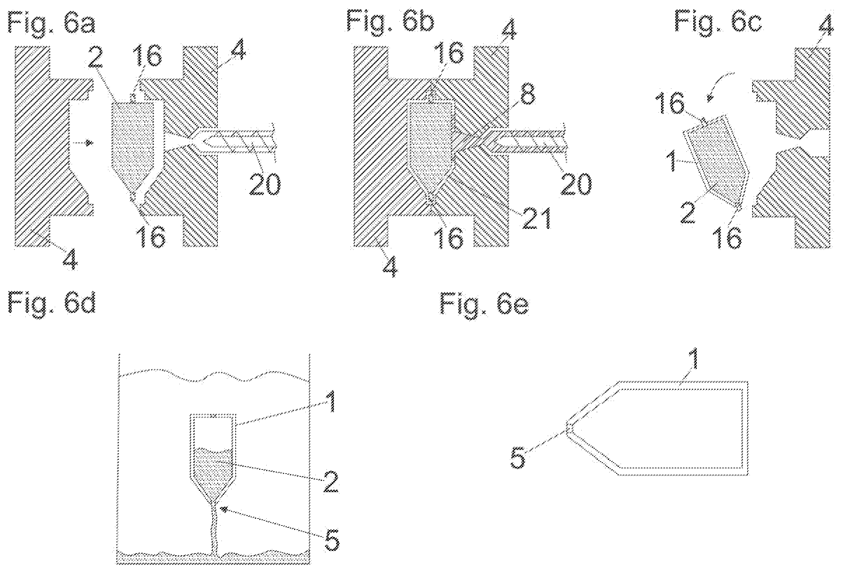

FIGS. 6a through 6c diagrammatically show various steps in the method according to the invention, the mold core 2 being held in a tool mold 4 by way of the holding means 16 in FIG. 6a. The mold 4 is then closed and liquid plastic melt is injected into the mold 4, for example by way of a plasticizing screw 20 of a plastic injection molding machine. That can be for example a thermoplastic material.

FIG. 6b shows how liquiid plastic melt 8 is injected into the mold 4 by the plasticizing screw 20 and the mold core 2 is surrounded with plastic melt 8 by being arranged in the cavity 21. No plastic melt 8 is arranged in the holding regions 3, in which the holding means 16 are arranged. Here therefore openings 5 remain in the operating fluid tank 1.

FIG. 6c diagrammatically shows the step of removal from the mold, in which the blank with the operating fluid tank 1, the holding means and the mold core 2 arranged within the operating fluid tank 1 is removed from the mold 4.

FIG. 6d diagrammatically shows how the mold core 2 is flushed out of the interior of the operating fluid tank 1 for example with water or a solution. In that situation the mold core material can flow out by way of the opening 5.

The finished component is diagrammatically shown in FIG. 6e. For the sake of better clarity functional elements 7 or transferred structural features 10 are not shown here.

### LIST OF REFERENCES

1 operating fluid tank
2 mold core with segments 2a, 2b, 2c
3 holding region
4 tool mold
5 operating fluid tank opening
6 structural element
7 functional element
8 plastic melt
9 inside surface of the operating fluid tank
10 structural feature
11 operating fluid tank interior
12 sensor
13 fixing element
14 region with rough surface
15 cable duct
16 holding means
17 connecting means
18 region with smooth surface
19 clip
20 plasticzing screw
21 cavity

1. A method of producing an operating fluid tank of plastic for a motor vehicle including the following steps:
providing a mold core produced from a, preferably pourable or flowable, mold core material, wherein the mold core has at least one holding region, by way of which the mold core is held in a tool mold or in a plastic molding machine,
surrounding the mold core with a plastic melt, wherein at least one opening remains in the operating fluid tank in the at least one holding region, by way of which the mold core is held in a tool mold or a plastic molding machine, and
removing the mold core material from the operating fluid tank by way of the remaining opening,
wherein a preferably metallic and/or ceramic structural element is arranged at a limited portion of the mold core, that is separate from the at least one holding region, and is held by the mold core while being surrounded with the plastic melt, wherein while being surrounded with the plastic melt an inner surface of the operating fluid tank is formed, to which a structural feature arranged on the structural element is transferred while being surrounded with the plastic melt and wherein the structural element is removed from the operating fluid tank through the remaining opening after at least partial hardening of the plastic melt.

2. A method of producing an operating fluid tank of plastic for a motor vehicle including the following steps:
providing a mold core produced from a, preferably pourable or flowable, mold core material, wherein the mold core has at least one holding region, by way of which the mold core is held in a tool mold or in a plastic molding machine,
surrounding the mold core with a plastic melt, wherein at least one opening remains in the operating fluid tank in the at least one holding region, by way of which the mold core is held in a tool mold or a plastic molding machine, and
removing the mold core material from the operating fluid tank by way of the remaining opening,
wherein a stable-shape functional element is arranged at a limited portion of the mold core, that is separate from the at least one holding region, and is held by the mold core while being surrounded with the plastic melt, wherein while being surrounded with the plastic melt an inner surface of the operating fluid tank is formed, to which the functional element is connected while being surrounded with the plastic melt and wherein the functional element is held in material-bonded and/or positively locking relationship after hardening of the plastic melt and removal of the mold core material by the operating fluid tank in such a way that the functional element has access to the interior of the operating fluid tank.

3. The method as set forth in claim 1, wherein the structural feature is formed by a smooth surface of the structural element.

4. The method as set forth in claim 1, wherein the structural element has a flat surface region on which the structural element is arranged.

5. The method as set forth in claim 2, wherein the functional element includes an electronic functional element, preferably a sensor and/or a transmitting-receiving unit.

6. The method as set forth in claim 2, wherein the functional element includes a sealing element and/or a fixing element.

7. The method as set forth in claim 1, wherein the functional element and/or the structural element is held in positively locking and/or force-locking and/or material-bonded relationship by the mold core while being surrounded with plastic melt.

8. The method as set forth in claim 1, wherein the mold core has two holding regions, by way of which the mold core is held in a tool mold or a plastic molding machine.

9. The method as set forth in claim 1, wherein arranged at the at least one holding region is a preferably metallic holding means with which the mold core is held in a tool mold or a plastic molding machine.

10. The method as set forth in claim 1, wherein the mold core is composed of at least two segments, wherein each two segments are connected together by way of connecting means and wherein the one or more connecting means after the core is surrounded with the plastic melt is or are removed from the operating fluid tank through the remaining opening.

11. The method as set forth in claim 1, the mold core comprises sand or foam balls.

12. The method as set forth in claim 11, wherein the mold core has a casing comprising a soluble or crushable material.

13. The method as set forth in claim 1, wherein the mold core is produced by means of a 3D printing process.

14. A mold core for the production of an operating fluid tank of plastic for a motor vehicle according to the method as set forth in claim 1.

15. An operating fluid tank for a motor vehicle, in particular produced according to the method as set forth in claim 1, wherein the operating fluid tank is injection molded from a plastic.
